(19) United States
(12) Patent Application Publication
(10) Pub. No.: US 2006/0222341 A1
(43) Pub. Date: Oct. 5, 2006

(54) Image acquisition apparatus and data recording method

(75) Inventors: Tatsuhiko Ikehata, Ome-shi (JP); Yoshihide Uchida, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/393,821

(22) Filed: Mar. 31, 2006

(30) Foreign Application Priority Data
Mar. 31, 2005 (JP) 2005-100294

(51) Int. Cl. H04N 5/91

(52) U.S. Cl. 386/107

(57) ABSTRACT

According to one embodiment, an image acquisition apparatus includes a removable recording medium which is attached to a recording medium requiring certain time for starting up, and configured to record data when only a system program is started, an image processing unit which generates an image signal to be recorded, a switching control unit which causes the attached recording medium to record an image signal generated by the image processing unit during startup of the attached recording medium, wherein information can be recorded in a short time after a main power supply is turned on.

### CROSS-REFERENCE TO RELATED APPLICATIONS

This application is based upon and claims the benefit of priority from Japanese Patent Application No. 2005-100294, filed Mar. 31, 2005, the entire contents of which are incorporated herein by reference.

### BACKGROUND

1. Field

One embodiment of the invention relates to an image acquisition apparatus such as an electronic camera and a method of guiding operations of the apparatus, and in particular to a recording method capable of decreasing a waiting time during startup and an image acquisition apparatus capable of recording it.

2. Description of the Related Art

An electronic camera apparatus can record still and moving images in a recording medium, such as a semiconductor memory (a memory card) and a hard disk unit. As a hard disk unit has become compact and large capacity in recent years, a number of images (still images) can be recorded and a number of titles or long time of moving image can be recorded (saved).

An apparatus incorporated with a hard disk unit, which can record several 100 to several 1000 number of still image and moving image (title), has been proposed. However, it is known that the time required for checking a system during system startup or starting a hard disk unit is not negligible (about several seconds), missing a shutter chance.

Japanese Patent Application Publication (KOKAI) No. 2003-189165 proposes starting a system by reading only a startup program into a buffer memory, and then checking information of a memory card, in a digital camera.

Japanese Patent Application Publication (KOKAI) No. 2001-209545 proposes a method of starting a digital camera by executing a program in two steps, that is, starting a startup program, and then reading a necessary program according to an operation mode.

However, both Publications 2003-189165 and 2001-209545 merely disclose a method of decreasing the time required to start a system, and does not mention the waiting time required by a system to become ready for recording still and moving images, in an image acquisition apparatus having a large capacity recording medium such as a hard disk unit. They offer no proposal about the waiting time required for starting up a hard disk unit, particularly when using a hard disk unit as a recording medium.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are exemplary diagrams each shows an example of an electronic camera apparatus (image acquisition apparatus) capable of recording still and moving images and voices, according to an embodiment of the invention;

FIG. 2 is an exemplary diagram showing a control system of the electronic camera apparatus according to an embodiment of the invention shown in the FIGS. 1A and 1B;

FIG. 3A is an exemplary flowchart showing the characteristic operation of an example of the electronic camera apparatus shown in FIGS. 1A, 1B and 2, according to an embodiment of the invention;

FIG. 3B is an exemplary flowchart showing the characteristic operation of an example of the electronic camera apparatus shown in FIGS. 1A, 1B and 2, according to an embodiment of the invention;

FIG. 3C is an exemplary flowchart showing the characteristic operation of an example of the electronic camera apparatus shown in FIGS. 1A, 1B and 2, according to an embodiment of the invention;

FIGS. 4A and 4B are exemplary diagrams each showing an example of a screen display capable of displaying “Starting” and “End of Startup” of the camera apparatus, according to an embodiment of the invention; and

FIG. 5 is an exemplary flowchart showing an example of control to make a screen recordable during “Starting” of the camera apparatus, according to an embodiment of the invention.

### DETAILED DESCRIPTION

Various embodiments according to the invention will be described hereinafter with reference to the accompanying drawings. In general, according to one embodiment of the invention, an image acquisition apparatus includes a removable recording medium which is attached to a recording medium requiring certain time for starting up, and configured to record data when only a system program is started, an image processing unit which generates an image signal to be recorded, a switching control unit which causes the attached recording medium to record an image signal generated by the image processing unit during startup of the attached recording medium, wherein information can be recorded in a short time after a main power supply is turned on.

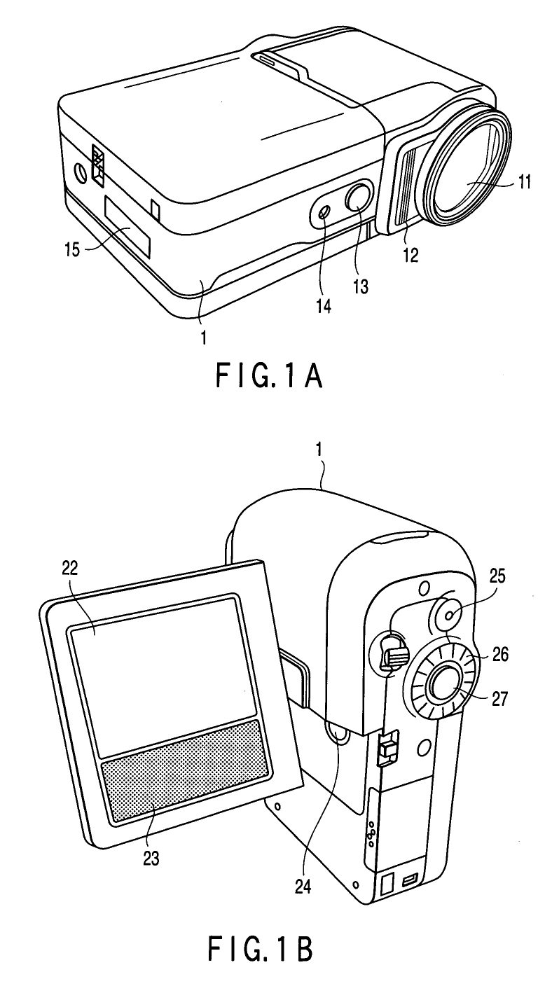

FIGS. 1A and 1B show schematic illustrations of an electronic camera apparatus capable of recording still and moving images and voices, to which an embodiment of the present invention is applicable.

FIG. 1A shows an electronic camera apparatus (an image acquisition apparatus) 1 viewed from the camera lens side. The electronic camera apparatus 1 has a camera lens 11, a flash 12, a shutter button 13 (for a still image), and a remote control receiver 14. The camera apparatus 1 also has an adapter connector (a connection terminal) 15 used for connection with a personal computer and an external power supply (a charger).

FIG. 1B shows the electronic camera apparatus 1 viewed from the opposite side of the camera lens 11.

The electronic camera apparatus 1 has a liquid crystal monitor (LCD panel) 22 and a speaker 23 provided integrally with a frame 21 functioning also as a main power switch. The electronic camera apparatus 1 also has a main power switch 24 at a fixed position, which is turned off at the position where the frame 21 is closed (housed at a fixed position of the main body of the electronic camera).

The electronic camera apparatus 1 has a record button 25 capable of inputting instructions (commands) to start and stop recording a moving image, a jog (JOG) dial 26 capable of inputting instructions (control commands) to input operation modes and conditions and select decisions, and a set (OK) button 27 capable of inputting an instruction (a control command) to determine (execute) the instruction selected (guided) by the jog dial 26, at predetermined positions. The OK (set) button 27 is placed coaxially (concentrically) with the center of rotation of the job dial 26.

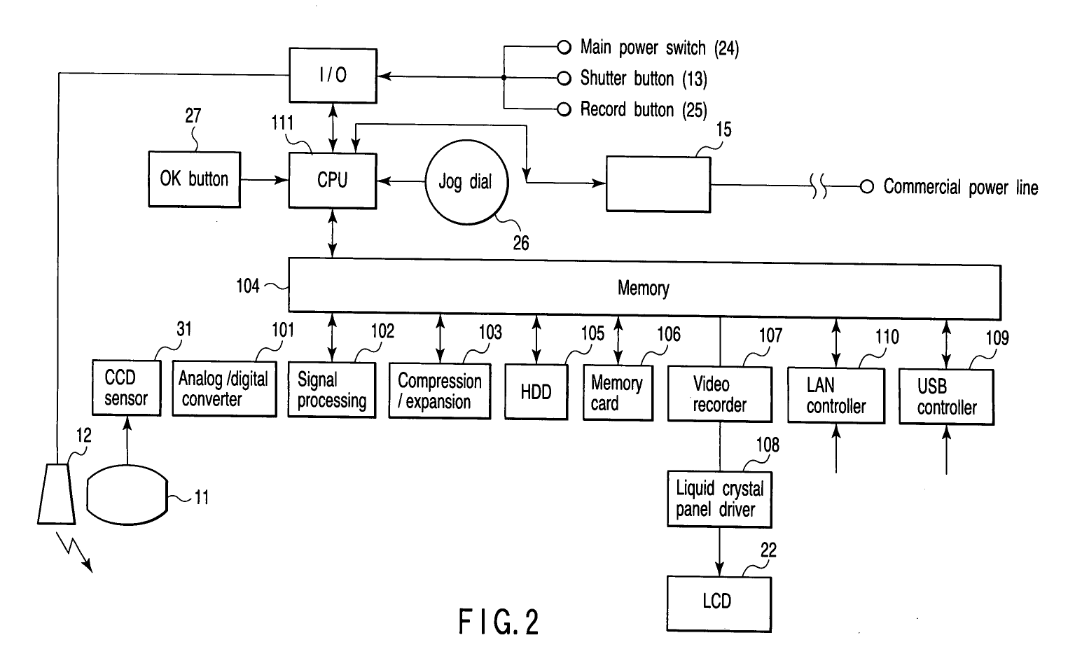

FIG. 2 shows an example of a control block of the electronic camera apparatus 1 shown schematically in FIGS. 1A and 1B.

A subject image taken by the camera lens 11 is focused on an image forming plane of the image pickup element 31, or a CCD sensor, for example, and converted to an analog signal (taken image data).

The analog signal (taken image data) from the CCD sensor 31 is converted to a digital signal in an analog-to-digital converter 101 controlled by a CPU (main control circuit) 111, and input to a camera signal processing circuit 102.

The camera signal processing circuit 102 performs gamma correction, color signal separation or white balance adjustment for the taken image data converted to a digital signal by the analog-to-digital converter 101.

The taken image data output from the camera signal processing circuit 102, or a recording image taken by the camera lens 11, is input to a liquid crystal panel driver (LCD Driver) 108, and displayed on an LCD panel 22 (hereinafter called LCD) mounted in the frame 21 (refer to FIG. 1B).

The taken image data output from the camera signal processing circuit 102 is compressed in a compression/expansion unit 103, when recording, and recorded in a main recording medium, for example, a hard disk unit 105 (hereinafter abbreviated as HDD) or an attached removable recording medium, for example, a memory card 106, or a nonvolatile memory.

The compression/expansion unit 103 compresses a still image by a known method such as JPEG, and a moving image (a non-still image) by MPEG. The memory card 106 may use a SD card (registered trademark) and Mini-SD (registered trademark) card semiconductor memory.

When playing an image recorded in the HDD 105 or memory card 106, an image read from the HDD 105 or memory card 106 is expanded in the compression/expansion unit 103, and supplied to a video decoder 107 through a memory circuit 104. The image data supplied to the video decoder 107 is displayed in the LCD 22 through the liquid crystal panel driver 108.

A not-shown recording media interface is used for the transfer of data (compressed image) with the HDD 105 and memory card 106. Instead of the HDD 105, an optical disc can be used. Of course, it is also possible to use a large capacity memory card as a main recording medium.

Still image or moving image data recorded in the HDD 105 or memory card 106 can be transferred to a not-shown external unit, such as a personal computer (PC) and a video recorder. An interface controller 109 can be used for the transfer with an external unit. Of course, a known standard, for example IEEE 1394, a Universal Serial Bus (USB) and a parallel bus can be used as an interface.

In this case, the interface controller 109 is inserted between an optional interface and the memory circuit 104. Of course, a network (LAN) connected through a LAN controller 110 can be used for the transfer of data.

By using the large capacity HDD 105 as a recording medium, the recordable number of still images or the time to record moving images (the number of titles) reaches several 100 to several 1000. Thus, a high speed is demanded to feed the recorded images or titles forward and backward. Therefore, the jog dial 26 and OK button 27 permit selection of many images or titles and setting of operation modes without stress. (An easy-to-use switch such as the jog dial 26 is useful when specifying an image by continuously searching many images or titles.)

The OK (set) button 27 gives the CPU 111 information that the button 27 is pressed (ON/OFF signal is input). Based on the ON/OFF signal input from the information (the button 27), the CPU 111 determines the image/title or mode selected by the jog dial 26, and plays the image/title or sets the mode.

The jog dial 26 gives the CPU (main control unit) 111 information about the rotation angle and speed. The CPU 111 can control the (next) image display speed from the information.

Of course, a not-shown work memory (called RAM or cache) is provided for processing image data, as firmware of the CPU 111, or as a part of the memory circuit 104, or as an external memory connected to the memory circuit 104. When a relatively large capacity is given as a cache memory, a part of the recording area of the HDD 105 may be allocated.

Now, explanation will be given on the characteristics of the invention in the electronic camera apparatus shown in FIGS. 1A, 1B and FIG. 2.

The invention proposes displaying image data output from the CCD sensor 31 and converted to a digital signal in the liquid crystal panel (LCD) 22 in the shortest time after a main power supply is turned on. Namely, an image is displayed in the LCD 22, regardless of the state of the HDD 105 as a recording unit, after the main power supply is turned on.

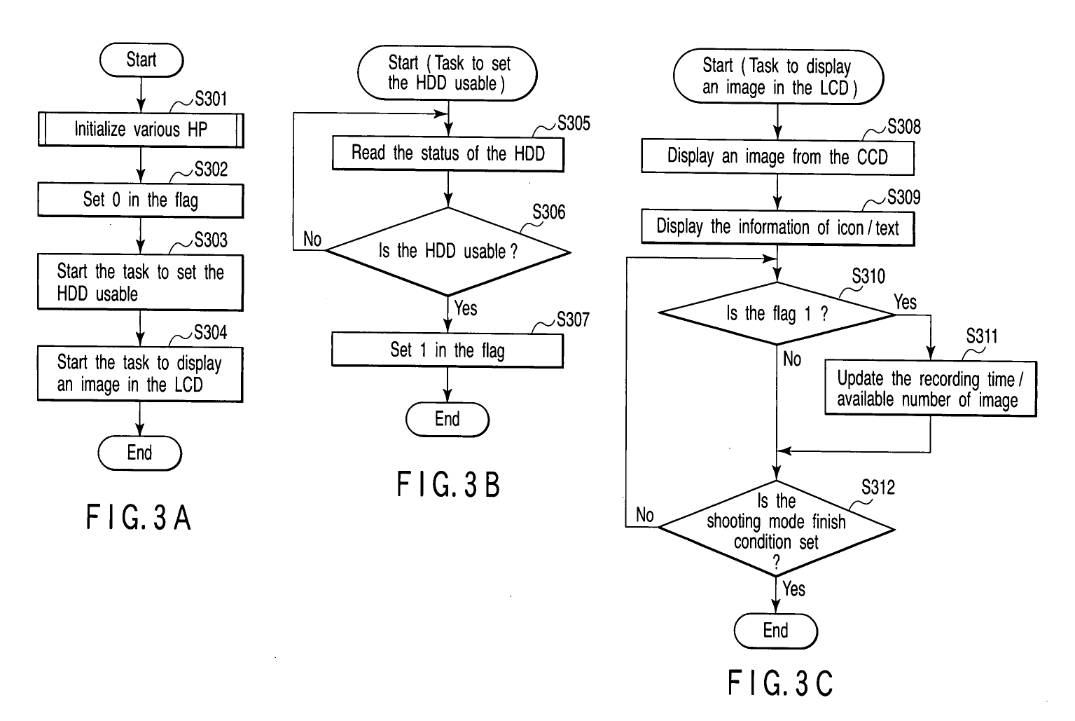

As shown in FIG. 3A, when the image acquisition apparatus (electronic camera apparatus) is powered (the main power switch 24 is turned on by opening the frame 21 incorporated with the LCD 22), initialization of various hardware such as for checking the positions of the CCD sensor 31 and camera lens 11 (HP, or home positions) is executed (S301).

Set “0”, unusable, for example, in a flag to judge whether the HDD 105 is set usable (started up (normally) to be recordable) (S302).

Start a task to set the HDD 105 usable (S303).

Start a task to display an image in the LCD 22 (a task to start displaying an image in the LCD 22 by the liquid crystal panel driver 108) (S304).

By steps S303 and S304, the task to set the HDD 105 usable and task to display an image in the LCD 22 are operated substantially simultaneously (two task are simultaneously executed). By setting the priority of the task to set the HDD 105 usable lower than the priority of the task to display an image in the LCD 22, a process to examine whether the HDD 105 is set usable can be executed while the task to display an image in the LCD 22 is resting (during a short time gap in timesharing).

The task to display an image in the LCD 22 can execute a task with lower priority, by stopping a task for a certain time after checking whether a shooting mode finish condition is set (S312).

The task to set the HDD 105 usable reads the state of the HDD 105 (e.g., residual recording area, rotation speed, end of reading normal data from a system program area, and starting a startup routine based on that program) (called status reading, S305), and repeats it until the HDD 105 becomes usable, as shown in FIG. 3B (S306).

When the HDD 105 becomes usable (S306—Yes), set “1”, usable, for example in the flag to judge whether the HDD 105 is set usable. Namely, the flag set to “0” in step S302 is rewritten to “1” (S307).

The task to display an image in the LCD 22 displays an image sent from the CCD sensor 31 in the LCD 22 by the liquid crystal panel driver 108 (S308), and overlays an icon or text as other information on that image (S309), as shown in FIG. 3C. By displaying an actually taken image through the camera lens 11 during startup of the HDD 105, as described above, failure to take off a not-shown lens cap to protect the camera lens 11 (failure to open a shutter in case of integral-type shutter) can be securely prevented.

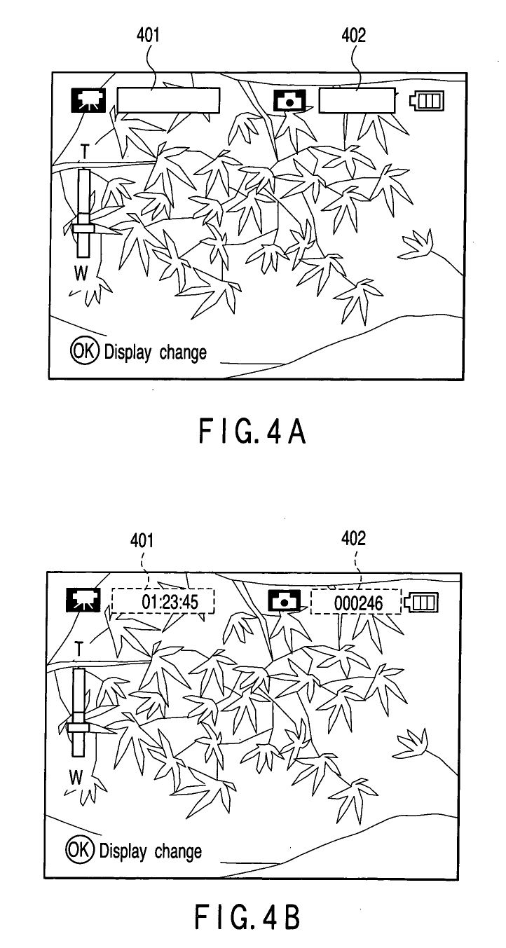

When the flag to indicate whether the HDD 105 is usable is “0” indicating unusable (during startup) (S310—No), “Starting” is set and nothing (blank) is displayed in an area 401 to indicate the recordable time and an area 402 to indicate an available number of image of the LCD 22, and the startup checking, that is, checking that the shooting mode finish condition is set, meaning the end of the startup of shooting mode, is continued until the flag is set to “1” (S312), as shown in FIG. 4A.

Contrarily, When the flag to indicate whether the HDD 105 is usable is “1” indicating usable (the end of startup) (S310—Yes), the recordable time and available number of image are read, and the recordable time and recordable (recorded) number of image are displayed in the area 401 to indicate the recordable time and area 402 to indicate the available number of image of the LCD 22, respectively as shown in FIG. 4B (S311).

The display of usable (the end of startup) shown in FIGS. 4A and 4B is also possible (can also be displayed [notified]) by an access lamp provided previously in the image acquisition apparatus 1, or by lighting or flashing an LED to indicate the record/pause mode or an LED to indicate a recording medium used now for recording image data, or by combining two or more of them.

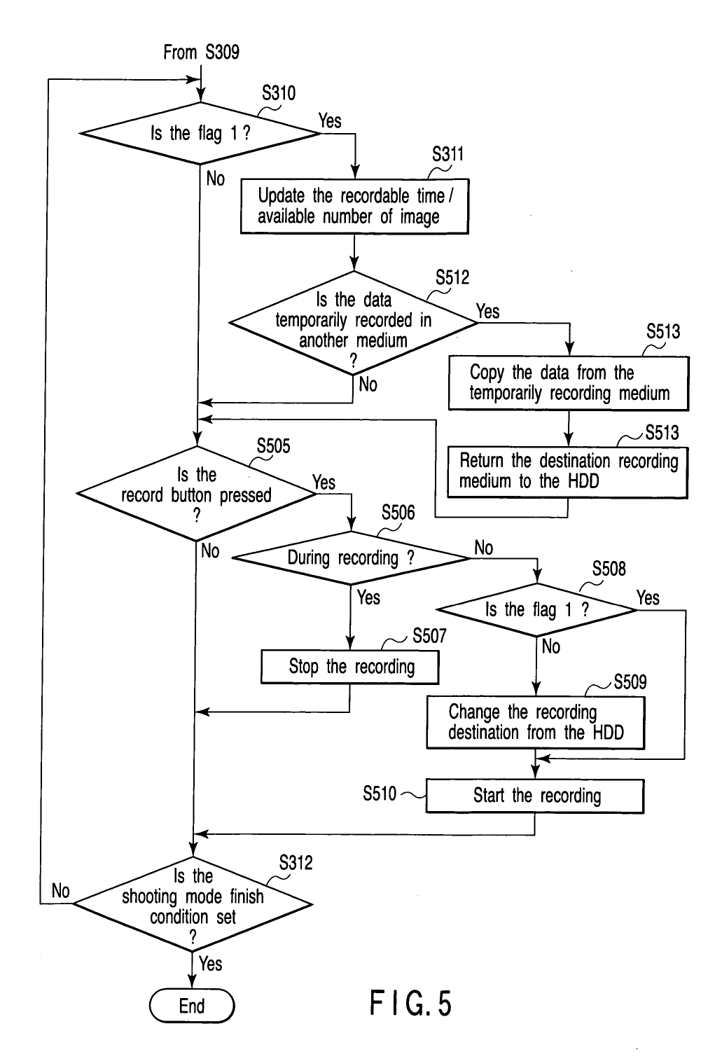

FIG. 5 shows an example of the operation of the electronic camera apparatus, when the record button is turned on (the record start signal is input) while the task to display an image in the LCD shown in FIG. 3C is being executed, that is, during the startup of HDD (while the HDD is in the unusable state).

As already explained, in the image acquisition apparatus (electronic camera apparatus) 1 using the HDD 105, it is difficult to completely eliminate the possibility of missing a photo opportunity during the waiting time during startup.

Thus, when the record button 25 (refer to FIG. 1B) is pressed during the execution of the task to display an image in the LCD 22 shown in FIG. 3C, that is, during startup of the HDD 105 (in the unusable state) (the record button 25 outputs an ON signal indicating that the button is pressed, whenever pressed) (S505—Yes), whether the current operation state is recording is checked (S506), and the recording is stopped (S507) when the current state is recording (S506—Yes).

When the current state is not recording (S506—No), whether the startup of the HDD 105 is finished, or whether the flag of the task to set the HDD 105 usable is “1” is checked (S508).

When the HDD 105 is being started in step D508, or when the task to set the HDD 105 usable is “0” (S508—No), a recording medium is changed from the HDD 105 (to the memory card 106 in this application). Namely, a recording medium to record an image taken by the camera lens 11 is changed from the default HDD 105 to the memory card 106 (S509).

Then, recording is started, and the data of image taken through the camera lens 11 is temporarily recorded in another recording medium, that is, the memory card 106 (S510).

Then, whether the shooting mode finish condition is set (the startup of the HDD is finished) is checked (S312). If the startup of the HDD is not finished (S312—No), whether the flag of the task to set the HDD 105 usable is “1” is checked again (S310).

If the flag to judge whether the HDD 105 is usable is “1” indicating usable (the end of the startup) (S310—Yes), the recordable time and available number of image are read, the recordable time and recordable (recorded) number of image are displayed in the area 401 to indicate the recordable time and area 402 to indicate the available number of image of the LCD 22, respectively as shown in FIG. 4B (S311), and whether image data is temporarily recorded in another recording medium (the existence of image data temporarily recorded in another recording medium) is checked (S512).

If the existence of image data temporarily recorded in another recording medium (memory card) is checked in step S512 (S512—Yes), the data recorded in the memory card 106 is copied to the HDD 105 and the data of the memory card is erased (the data is transferred to the HDD, S513).

When the data temporarily recorded in the memory card 106 is copied to the HDD 105 in step S513, the destination recording medium changed in step S509 is returned to the HDD 105 (S514).

Of course, when the record button 25 is pressed during recording, the recording is finished (stopped) (S507).

As explained hereinbefore, according to the present invention, as the input image data is recorded in another recording medium capable of recording image data during startup of a main recording medium (HDD) which requires relatively long time to start up (initialize), the waiting time during startup is reduced and the possibility of missing a photo opportunity is decreased.

Further, as an image taken through an image pickup system is displayed in a display monitor (LCD) after a system program is started up, failure to take off a lens cap to protect a camera lens of the image pickup system (failure to open a shutter in the case of integral-type shutter) can be securely prevented, and the possibility of missing a shutter chance is decreased furthermore.

In addition, displaying an image taken through an image pickup system in a display monitor (LCD) after startup of a system program is useful to increase the operability by the user during the waiting time (startup) (smooth operation is possible).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The invention is applicable also to a video camera using a tape as a recording medium, for example, without modifications. A camera may be a still camera for shooting (recording) a still image, using a large capacity memory card as a main recording medium, and an optional external recording medium as an auxiliary recording medium.

What is claimed is:

1. An image acquisition apparatus comprising:
a main recording medium capable of recording data, which requires certain time to be started up to a data recordable state;
a recording medium which is configured to record data when only a system program is started, and attached to the main recording medium;
an image processing unit which generates an image signal; and
a recording medium switching unit which causes the attached recording medium to record the image signal generated by the image processing unit during startup of the main recording medium.

2. The image acquisition apparatus according to claim 1, wherein the recording medium switching unit has a signal input unit to instruct switching of the recording medium.

3. The image acquisition apparatus according to claim 2, wherein the attached recording medium switched by the signal input unit is a RAM, and the image signal recorded in the RAM is moved to the main recording medium when the startup of the main recording medium is finished.

4. The image acquisition apparatus according to claim 2, wherein the attached recording medium switched by the signal input unit is a removable semiconductor memory, and the image signal recorded in the semiconductor memory is moved to the main recording medium when the startup of the main recording medium is finished.

5. The image acquisition apparatus according to claim 1, further comprising an image display unit which is configured to display the image signal generated by the image processing unit when only the system program is started even during the startup of the main recording medium.

6. The image acquisition apparatus according to claim 5, further comprising a signal input unit which instructs the recording medium switching unit to switch the recording medium.

7. The image acquisition apparatus according to claim 6, wherein the attached recording medium switched by the signal input unit is a RAM, and the image signal recorded in the RAM is moved to the main recording medium when the startup of the main recording medium is finished.

8. The image acquisition apparatus according to claim 6, wherein the attached recording medium switched by the signal input unit is a removable semiconductor memory, and the image signal recorded in the semiconductor memory is moved to the main recording medium when the startup of the main recording medium is finished.

9. An image acquisition apparatus comprising:
a lens which takes information to be recorded;
an image signal generation unit which generates a signal corresponding to the information taken by the lens;
a main recording medium which has a large capacity though requiring time for starting up, and records an image signal generated by the image signal generation unit;
a recording medium which is configured to record the image signal when only a system program is started, and attached to the main recording medium;
a display unit which displays an image corresponding to the image signal generated by the image signal generation unit;
an image display control unit which processes the image signal to be displayable and supplies to the display unit; and
a recording medium switching unit which causes the attached recording medium to record the image signal generated by the image processing unit during startup of the main recording medium.

10. The image acquisition apparatus according to claim 9, wherein the recording medium switching unit causes the display unit to display an image corresponding to the image signal.

11. A data recording method comprising:
starting a system program when a main power supply is turned on;
recording data in a first recording medium configured to record data, when the system program is started;
transferring the data recorded in the first recording medium to a second recording medium, when startup of the second recording medium requiring certain time for starting up to a data recordable state is finished; and
recording subsequently supplied data in the recording medium.
